(19) United States
(12) Patent Application Publication
(10) Pub. No.: US 2025/0035883 A1
(43) Pub. Date: Jan. 30, 2025

(54) OPTICAL APPARATUS

(71) Applicant: CANON KABUSHIKI KAISHA, Tokyo (JP)

(72) Inventor: KOHEI UEMURA, Tokyo (JP)

(21) Appl. No.: 18/918,458

(22) Filed: Oct. 17, 2024

Related U.S. Application Data
(63) Continuation of application No. PCT/JP2023/014710, filed on Apr. 11, 2023.

(30) Foreign Application Priority Data
Apr. 22, 2022 (JP) 2022-070948

(51) Int. Cl. G02B 7/09

(52) U.S. Cl. CPC G02B 7/09

(57) ABSTRACT

An optical apparatus includes a guide barrel configured to hold a lens unit movably in an optical axis direction, a cam barrel rotatably held by the guide barrel, a detecting member including a detection engaging part, and configured to perform a position detection of the lens unit by a movement of the detection engaging part, and a fixed barrel in which the guide barrel, the cam barrel, and the detecting member are disposed. The detection engaging part is engaged with a detection engaged part provided on the cam barrel. The detecting member is movable in the optical axis direction relative to the cam barrel.

### CROSS-REFERENCE TO RELATED APPLICATIONS

This application is a Continuation of International Patent Application No. PCT/JP2023/014710, filed on Apr. 11, 2023, which claims the benefit of Japanese Patent Application No. 2022-070948, filed on Apr. 22, 2022, which are hereby incorporated by reference herein in their entirety.

### BACKGROUND

### Technical Field

The present disclosure relates to an optical apparatus.

### Description of Related Art

Optical apparatuses, such as digital cameras, video cameras, and interchangeable lenses, are demanded to have a magnification-varying function, a reduced size in a barrel diameter direction, and a reduced overall length.

In order to detect a lens position of a magnification-varying lens barrel, each of Japanese Patent Laid-Open Nos. 2013-242356 and 2016-142905 discloses the lens barrel that has a position detecting groove provided in a cam barrel configured to hold a lens unit so that the lens unit can move in an optical axis direction, or in an operation ring connected to the cam barrel, wherein a detector of a position detecting unit fixed to a fixed barrel is engaged with the groove.

However, Japanese Patent Laid-Open No. 2013-242356 requires the position detecting groove provided in the operation ring to have a lift amount equivalent to a detecting range of the position detecting unit, and thus the miniaturization of the lens barrel is hindered.

Furthermore, Japanese Patent Laid-Open No. 2016-142905 requires the position detecting groove provided in the cam barrel to have a lift amount equivalent to a detecting range of the position detector, and thus the miniaturization of the lens barrel is hindered.

### SUMMARY

An optical apparatus according to one aspect of the disclosure includes a guide barrel configured to hold a lens unit movably in an optical axis direction, a cam barrel rotatably held by the guide barrel, a detecting member including a detection engaging part, and configured to perform a position detection of the lens unit by a movement of the detection engaging part, and a fixed barrel in which the guide barrel, the cam barrel, and the detecting member are disposed. The detection engaging part is engaged with a detection engaged part provided on the cam barrel. The detecting member is movable in the optical axis direction relative to the cam barrel.

An optical apparatus according to another aspect of the disclosure includes a guide barrel configured to hold a lens unit movably in an optical axis direction, a cam barrel rotatably held by the guide barrel, a detecting member including a detection engaging part, and configured to perform a position detection of the lens unit by a movement of the detection engaging part, and a fixed barrel in which the guide barrel, the cam barrel, and the detecting member are disposed. The detection engaging part is engaged with a detection engaged part provided on the guide barrel. The detecting member is movable in the optical axis direction relative to the guide barrel.

Further features of the disclosure will become apparent from the following description of embodiments with reference to the attached drawings.

### BRIEF DESCRIPTION OF THE DRAWINGS

FIGS. 1A and 1B are a front perspective view and a rear perspective view of an interchangeable lens and a digital camera, respectively.

FIG. 2 is a block diagram illustrating a configuration of the interchangeable lens and the digital camera.

FIG. 3 is a sectional view of the interchangeable lens at a wide-angle end.

FIG. 4 is a sectional view of the interchangeable lens at a telephoto end.

FIG. 5 is a sectional view of the interchangeable lens at a retracted end.

FIG. 6 is an exploded perspective view of an image stabilizing drive unit of the interchangeable lens and its peripheral members.

FIGS. 7A to 7C are sectional views illustrating a relationship between a zoom detector and a cam barrel.

FIG. 8 explains a movable range of a detecting knob of the zoom detector.

FIGS. 9A to 9C are developed views of an inner diameter of the cam barrel.

FIG. 10 is a sectional view illustrating a relationship between the zoom detector and a linear guide barrel.

### DETAILED DESCRIPTION

Referring now to the accompanying drawings, a detailed description will be given of embodiments according to the disclosure. Corresponding elements in respective figures will be designated by the same reference numerals, and a duplicate description thereof will be omitted. In each embodiment, an interchangeable lens will be described as an example of an optical apparatus, but a lens integrated type camera or the like may also be used.

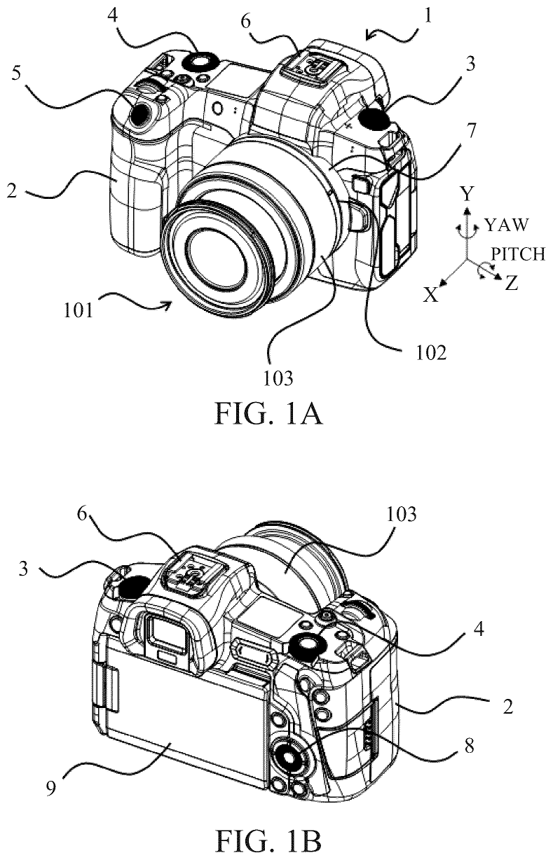

FIGS. 1A and 1B illustrate an external appearance of the interchangeable lens 101 and a digital camera (hereinafter referred to as a camera body) 1 to which the interchangeable lens 101 is detachably attached. FIG. 1A is a perspective view of a front side of the camera body 1, and FIG. 1B is a perspective view of a rear side of the camera body 1. As illustrated in FIG. 1A, an optical axis direction in which an optical axis of an imaging optical system housed in the interchangeable lens 101 extends is defined as an X-axis direction, and two directions perpendicular to the X-axis are defined as a Z-axis direction (a horizontal direction) and a Y-axis direction (a vertical direction). Hereinafter, the Z-axis direction and the Y-axis direction will be collectively referred to as Z/Y-axis directions. In addition, a rotation direction around the Z-axis is defined as a pitch direction, and a rotation direction around the Y-axis is defined as a yaw direction. The pitch direction and the yaw direction (hereinafter collectively referred to as pitch/yaw directions) are rotation directions around two axes of the Z-axis and the Y-axis, which are perpendicular to each other.

A grip unit 2 for a user to hold the camera body 1 in his hand is provided on a left side when viewed from the front (a right side when viewed from the rear) of the camera body 1. Furthermore, a power operation unit 3 is disposed on a top surface of the camera body 1. When the user turns on the power operation unit 3 while the camera body 1 is in a power-off state, power supply is started and the camera body 1 enters a power-on state. In the power-on state, a computer program such as origin detecting processing for a focus unit is executed, and the camera body 1 enters an imaging standby state. Conversely, when the user turns off the power operation unit 3 while the camera body 1 is in the power-on state, the camera body 1 enters the power-off state.

Furthermore, a mode dial 4, a release button 5, and an accessory shoe 6 are provided on the top surface of the camera body 1. The user can switch an imaging mode by rotating the mode dial 4. The imaging mode includes a manual still image capturing mode, which allows the user to set an imaging condition such as a shutter speed and an aperture value (F-number) as desired, an auto still image capturing mode, which automatically provides a proper exposure amount, and a moving image capturing mode for capturing a moving image. Furthermore, by half-pressing the release button 5, the user can instruct the camera body 1 to perform an imaging preparation operation such as an autofocus (AF) and an auto-exposure control. When the user fully presses the release button 5, the user can instruct the camera body 1 to capture an image. An accessory such as an external flash is detachably attached to the accessory shoe 6.

The interchangeable lens 101 is mechanically and electrically connected via a lens mount 102 to a camera mount 7 provided on the camera body 1. The interchangeable lens 101 includes the imaging optical system configured to form an object image by imaging light from an object. A zoom operation ring 103 rotatable around the optical axis by a user operation is provided on an outer circumference of the interchangeable lens 101. When the zoom operation ring 103 is rotated by the user, a zoom unit included in the imaging optical system moves to a predetermined position corresponding to an angle of the zoom operation ring 103. Thereby, the user can perform imaging with a desired angle of view.

As illustrated in FIG. 1B, a rear operation unit 8 and a display unit 9 are provided on a rear surface of the camera body 1. The rear operation unit 8 includes a plurality of buttons and dials to which various functions are assigned. In a case where the camera body 1 is in the power-on state and the still or moving image capturing mode is set, the display unit 9 displays a through image (live-view image) of the object image captured by an image sensor 16, which will be described later. In addition, the display unit 9 displays an imaging parameter that indicates an imaging condition such as a shutter speed and an aperture value, and the user can change a setting value of the imaging parameter by operating the rear operation unit 8 while viewing the display. The rear operation unit 8 includes a playback button for instructing playback of a recorded captured image, and the captured image is played back and displayed on the display unit 9 when the user operates the playback button.

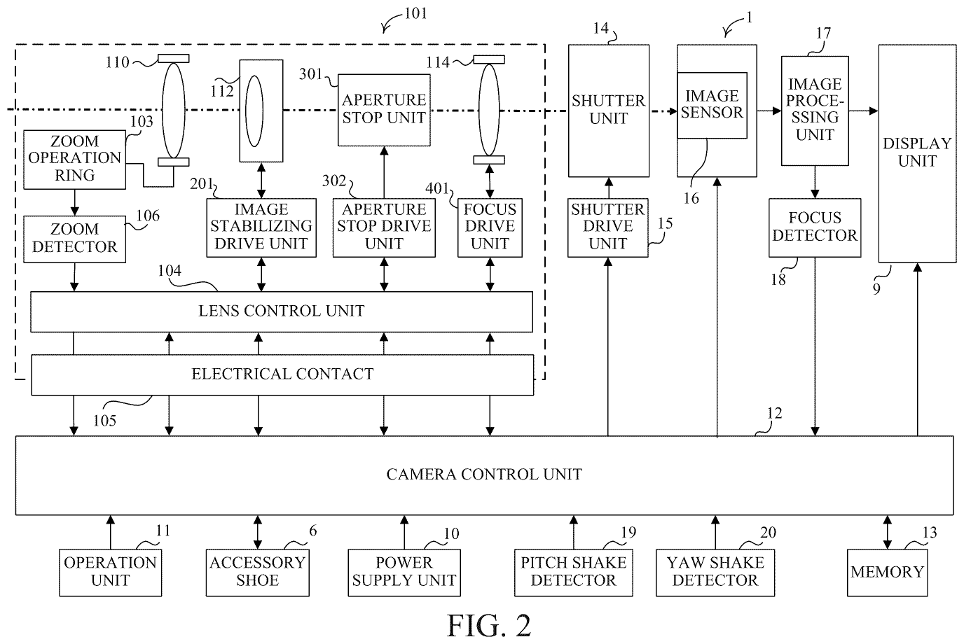

FIG. 2 is a block diagram illustrating an electrical and optical configuration of the interchangeable lens 101 and the camera body 1. The camera body 1 includes a power supply unit 10 configured to supply power to the camera body 1 and the interchangeable lens 101, and an operation unit 11, which includes the power operation unit 3, the mode dial 4, the release button 5, the rear operation unit 8, and a touch panel function of the display unit 9. The camera body 1 and the interchangeable lens 101 as a whole system are controlled by a camera control unit 12 provided in the camera body 1 and a lens control unit 104 provided in the interchangeable lens 101 in cooperation with each other. The camera control unit 12 reads out and executes a computer program stored in a memory 13. At that time, the camera control unit 12 communicates various control signals, data, and the like with the lens control unit 104 via a communication terminal of an electrical contact 105 provided on the lens mount 102. The electrical contact 105 includes a power supply terminal configured to supply power from the power supply unit 10 described above to the interchangeable lens 101.

The imaging optical system included in the interchangeable lens 101 includes a zoom unit 110 connected to the zoom operation ring 103 and configured to move in the optical axis direction to change an angle of view from a wide-angle position to a telephoto position, and an image stabilizing lens unit 112, which includes a shift lens as an image stabilizing element. Image blur is reduced by moving (shifting) the image stabilizing lens unit 112 in the Z/Y-axis directions perpendicular to the optical axis. The imaging optical system also includes an aperture stop (diaphragm) unit 301 configured to adjust a light amount, and a focus unit 114, which includes a focus lens configured to move in the optical axis direction for focusing. Furthermore, the interchangeable lens 101 has an image stabilizing drive unit 201 configured to move the image stabilizing lens unit 112, an aperture stop drive unit 302 configured to drive the aperture stop unit 301, and a focus drive unit 401 configured to move the focus unit 114. The interchangeable lens 101 has the zoom operation ring 103 for changing the angle of view of the imaging optical system, and a zoom detector (detecting member) 106 configured to detect a position of the zoom unit 110 by detecting an angle of a cam barrel 108 driven by the zoom operation ring 103.

The camera body 1 includes a shutter unit 14, a shutter drive unit 15 configured to drive the shutter unit 14, an image sensor 16, an image processing unit 17, and the camera control unit 12 described above. The shutter unit 14 controls a light amount to be imaged in the imaging optical system in the interchangeable lens 101 and exposed on the image sensor 16. The image sensor 16 photoelectrically converts an object image formed by the imaging optical system and outputs an imaging signal. The image processing unit 17 performs various image processing on the imaging signal, and then generates an image signal. The display unit 9 displays the image signal (a through image) output from the image processing unit 17, displays the imaging parameter as described above, and plays back and displays the captured image recorded in the memory 13 or a recording medium not illustrated.

The camera control unit 12 controls the focus drive unit 401 in response to an imaging preparation operation such as a half-press operation of the release button 5 in the operation unit 11. For example, in a case where an instruction on an operation of the autofocus is provided, the focus detector 18 determines a focus state of the object image formed by the image sensor 16 based on the image signal generated by the image processing unit 17, generates a focus signal, and transmits the focus signal to the camera control unit 12. At the same time, the focus drive unit 401 transmits information on a current position of the focus unit 114 to the camera control unit 12. The camera control unit 12 compares the focus state of the object image with the current position of the focus unit 114, calculates a focus drive amount from an amount of the deviation, and transmits the calculated amount to the lens control unit 104. Then, the lens control unit 104 moves the focus unit 114 to a target position in the optical axis direction via the focus drive unit 401. Thereby, a focus shift of the object image can be corrected.

The focus drive unit 401 includes a focus motor (not illustrated) and a photo-interrupter (not illustrated) configured to detect an origin position of the focus unit 114. Generally, a stepping motor, which is a type of actuator, is often used as the focus motor. However, since the stepping motor can only control a relative drive amount, while the camera body 1 is in the power-off state, the current position of the focus unit 114 is indefinite. In addition, even if the camera body 1 remains in the power-on state, in a case where the power supply to the interchangeable lens 101 is interrupted, for example by mechanically removing the interchangeable lens 101 from the camera mount 7 of the camera body 1, the focus unit 114 is held at the position at the cut-off time of the power supply. Thus, the current position of the focus unit 114 becomes indefinite. In a case where the user turns on the power operation unit 3 from such a state where the current position of the focus unit 114 is indefinite, the focus unit 114 must first be moved to the origin position and the origin detecting processing must be executed before the camera body 1 enters the imaging standby state. This control of the origin detecting processing is a well-known technology and has been adopted in many optical apparatuses, and thus a description thereof will be omitted. In addition, a DC motor or an ultrasonic motor equipped with an encoder may be used as the actuator. In addition, the photo-interrupter directly receives light emitted from a light emitter at a light receiver, but instead of this, a photo-reflector configured to receive reflected light from a reflective surface or a brush that contacts a conductive pattern to electrically detect a signal may be used.

Furthermore, the camera control unit 12 controls driving of the aperture stop unit 301 and the shutter unit 14 via the aperture stop drive unit 302 and the shutter drive unit 15 in accordance with the aperture value and the setting value of the shutter speed received from the operation unit 11, respectively. For example, in a case where an instruction on an auto-exposure control operation is provided, the camera control unit 12 receives a luminance signal generated by the image processing unit 17 and performs a photometry calculation. Based on a result of this photometry calculation, the camera control unit 12 controls the aperture stop drive unit 302 in response to an imaging instruction operation such as a full press of the release button 5 on the operation unit 11. At the same time, the camera control unit 12 controls the driving of the shutter unit 14 via the shutter drive unit 15, and performs exposure processing by the image sensor 16.

The camera body 1 has a pitch shake detector 19 and a yaw shake detector 20 as a shake detector configured to detect an image blur caused by manual shake of the user or the like. The pitch shake detector 19 and the yaw shake detector 20 each use an angular velocity sensor (a vibration gyro) and an angular acceleration sensor to detect the image blurs in the pitch direction (a rotation direction around the Z-axis) and the yaw direction (a rotation direction around the Y-axis) and output blur signals. The camera control unit 12 uses the shake signal from the pitch shake detector 19 to calculate a shift position of the image stabilizing lens unit 112 in the Y-axis direction. Similarly, the camera control unit 12 calculates a shift position of the image stabilizing lens unit 112 in the Z-axis direction using the shake signal from the yaw shake detector 20. Then, the camera control unit 12 moves the image stabilizing lens unit 112 to the target position in the Z/Y-axis directions via the image stabilizing drive unit 201 in accordance with the calculated shift positions in the pitch/yaw directions, thereby reducing the image blurs during exposure or during display of the through image.

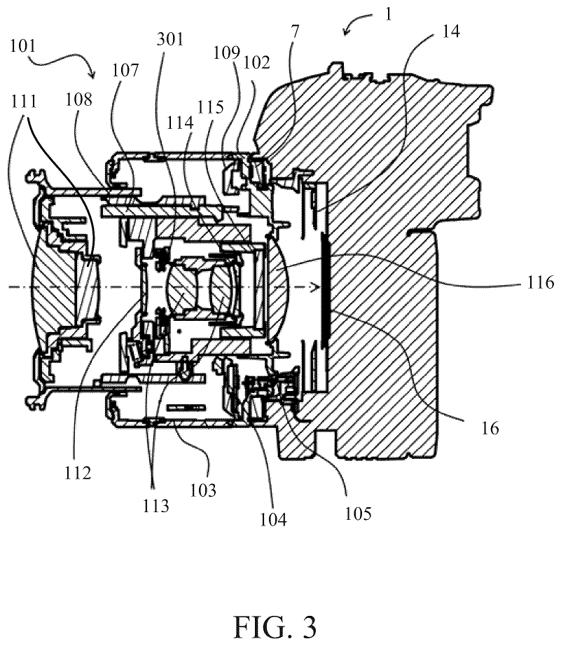

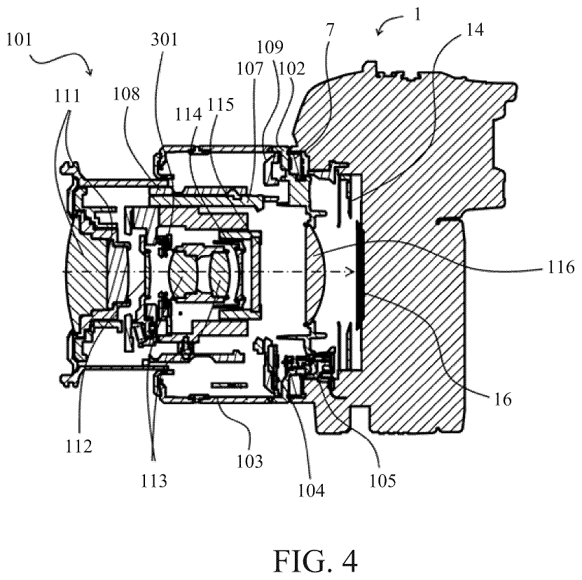

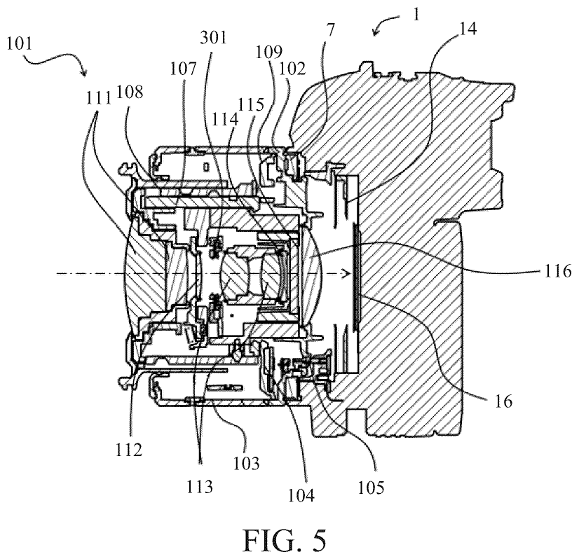

Referring now to FIGS. 3, 4, and 5, a description will be given of a positional relationship among main components of the interchangeable lens 101. FIG. 3 to FIG. 5 are sectional views of the interchangeable lens 101 on the XY plane including the optical axis, and a centerline illustrated here roughly coincides with the optical axis of the imaging optical system, and therefore will hereinafter be referred to as the optical axis. FIG. 3 is a sectional view of the interchangeable lens 101 at a wide-angle end on a short focus side during imaging. FIG. 4 is a sectional view of the interchangeable lens 101 at a telephoto end on a long focus side image capturing. In both FIGS. 3 and 4, imaging is available. FIG. 5 is a sectional view of the interchangeable lens 101 in a retracted state of the interchangeable lens 101 during non-imaging, and illustrates a retracted end that provides the shortest overall lens length in the optical axis direction.

As illustrated in FIGS. 3 and 4, each embodiment employs a six-unit configuration as an example of an imaging optical system. The zoom unit 110 moves to different predetermined positions at the wide-angle end and the telephoto end, and images light from the object on the image sensor 16. The zoom unit 110 includes a first zoom unit 111, the image stabilizing lens unit 112 functioning as a second zoom unit, the aperture stop unit 301, a third zoom unit 113, the focus unit 114 functioning as a fourth zoom unit, a fifth zoom unit 115, and a sixth zoom unit 116. Each embodiment is not limited to this configuration. For example, the image stabilizing lens unit 112 and the focus unit 114 may function as other zoom units. Furthermore, some of the lens units may not be movable but may be fixed.

A linear guide barrel (a guide barrel) 107 is a fixed component fixed to the lens mount 102 via a fixed barrel 109, and holds the zoom unit 110 so that the zoom unit 110 can move in the optical axis direction. The cam barrel 108 is connected to the zoom operation ring (an operation ring) 103 held on an outer circumference of the fixed barrel 109 via an unillustrated key. The cam barrel 108 is rotatably held by the linear guide barrel 107. When the zoom operation ring 103 is rotated, the cam barrel 108 rotates around the optical axis while its position in the optical axis direction is restricted by the linear guide barrel 107.

The linear guide barrel 107 has linear guide grooves 107a formed at equally spaced positions to restrict the movement of the zoom unit 110 in a rotation direction and to guide the linear movement of the zoom unit 110 in the optical axis direction. In addition, in the cam barrel 108, cam grooves 108b each having a different angular trajectory in the rotation direction are formed at equally spaced positions corresponding to the zoom unit 110. On the other hand, the zoom unit 110 includes a plurality of cam followers, each of which is engaged with a corresponding linear guide groove 107a and cam groove 108b. When the user rotates the zoom operation ring 103, the cam barrel 108 rotates, and the cam follower moves the zoom unit 110 back and forth in the optical axis direction while restricting the movement of the zoom unit 110 in the rotation direction by fitting into the linear guide groove 107a and the cam groove 108b.

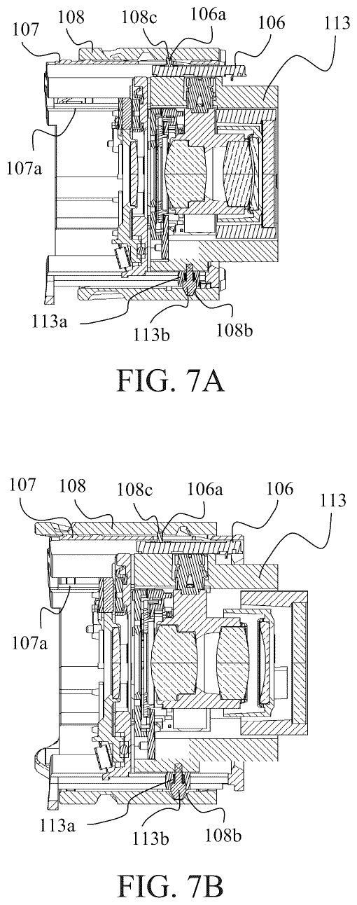

The interchangeable lens 101 includes the zoom operation ring 103 configured to change the angle of view of the imaging optical system, and the zoom detector (detecting member) 106 configured to perform the position detection of the zoom unit 110 by detecting an angle of the cam barrel 108 driven by the zoom operation ring 103. The zoom detector 106 detects the angle of the cam barrel 108 as an absolute value, and includes a linear displacement sensor, such as a linear potentiometer, which is a resistive sensor. In a configuration according to the first embodiment described below, a detecting knob (detection engaging part) 106a provided on the zoom detector 106 is engaged with a detecting groove (detection engaged part) 108c provided on an inner circumference of the cam barrel 108 (FIGS. 7A to 7C). Thereby, the detecting knob 106a moves, and a rotation angle of the cam barrel 108 is detected. Since the zoom operation ring 103 is not provided with the detecting groove 108c, a length of the zoom operation ring 103 in the optical axis direction can be shorter than that of the zoom detector 106. Information on the angle of view detected by the zoom detector 106 is transmitted to the lens control unit 104 and is reflected in various controls by the camera control unit 12 described above. On the other hand, some of these various pieces of information are recorded together with a captured image in the memory 13 or an unillustrated recording medium. The linear guide barrel 107, the cam barrel 108, and the zoom detector 106 are disposed inside the fixed barrel 109.

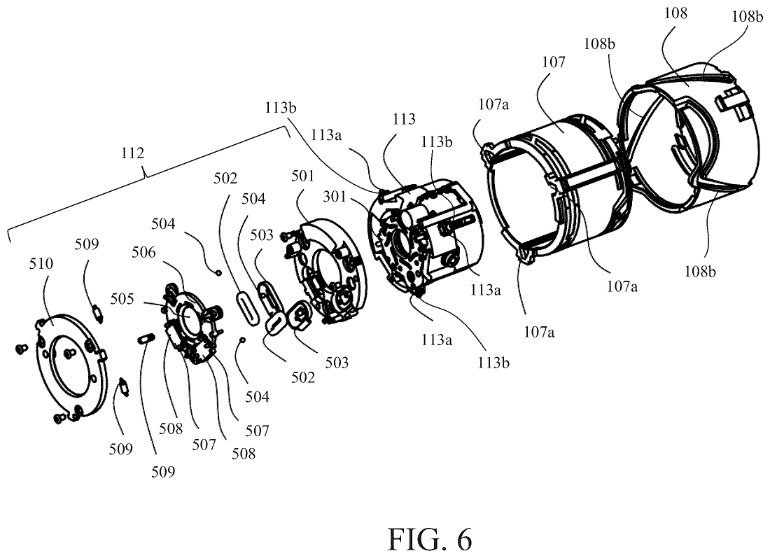

FIG. 6 is an exploded perspective view of the image stabilizing drive unit 201 of the interchangeable lens 101 and its peripheral members, with some of the components illustrated disassembled. The third zoom unit (a lens unit) 113 has a linear guide 113a which is a linear key, and a cam follower 113b. The linear guide groove 107a is provided on an inner side of the linear guide barrel 107, and engaged with the linear guide 113a to restrict the rotation of the third zoom unit 113 around an optical axis center. A base member 501 is connected to the third zoom unit 113. A coil 502 is connected to the base member 501 and is wired to the lens control unit 104 (not illustrated). A shield case 503 is connected to the base member 501, covers an image pickup plane side of the coil 502, and leaves an objective side open. A ball 504 is housed in the base member 501. A lens 505, which is an image stabilizing lens, is a component of the image stabilizing lens unit 112. A shift member 506 holds the lens 505 and is in contact with the ball 504. A magnet 507 is connected to the shift member 506 and is disposed opposite the coil 502 in the optical axis direction. A yoke 508 is connected to the magnet 507. A spring hook part of the base member 501 extends from the base member 501. The spring hook part of the shift member 506 extends from the shift member 506. A spring 509 is a resilient tension spring having a first hook and a second hook. The first hook of the spring 509 is engaged with the spring hook part of the base member 501. The second hook of the spring 509 is engaged with the spring hook part of the shift member 506. The spring 509 is disposed so that a longitudinal direction of the spring 509 forms an angle of 75° relative to the optical axis direction. Thereby, the shift member 506 is biased against the base member 501 and is disposed at a position where a tension of the spring 509 is balanced. Furthermore, when the lens control unit 104 electrifies the coil 502, the shift member 506 can be moved in a direction perpendicular to the optical axis relative to the base member 501 as a voice coil type actuator. A floating stop member 510 regulates the shift member 506 from floating up in the optical axis direction. Thereby, unintentional movement of the shift member 506 due to a drop impact or the like can be reduced.

### First Embodiment

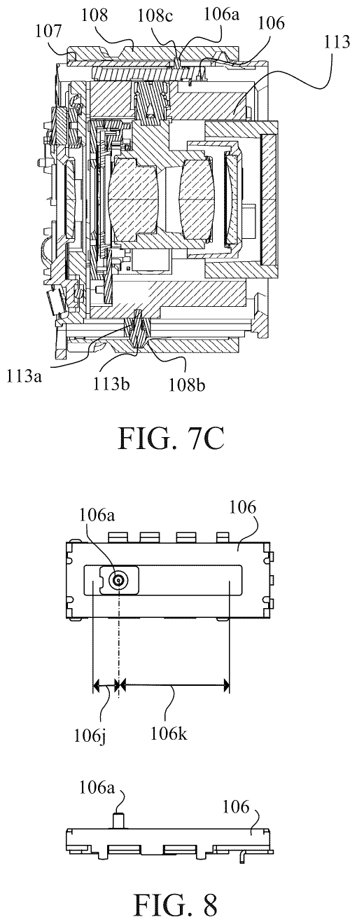

FIGS. 7A to 7C are sectional views illustrating a relationship between the zoom detector 106 and the cam barrel 108. FIG. 7A is a sectional view at a standby position in a non-imaging state, FIG. 7B is a sectional view at a wide-angle position in an imaging state, and FIG. 7C is a sectional view at a telephoto position in an imaging state. The zoom detector 106 is attached to the third zoom unit 113. The zoom detector 106 includes the detecting knob 106a, and the detecting knob 106a is engaged with the detecting groove 108c provided on the cam barrel 108. A movable range of the detecting knob 106a is divided into a non-imaging state detecting range 106j and an imaging state detecting range 106k (FIG. 8). When the cam barrel 108 rotates along with a rotation of the zoom operation ring 103, the third zoom unit 113 moves along the optical axis relative to the fixed barrel 109 since the cam follower 113b is engaged with the cam groove 108b. Thereby, since the zoom detector 106 is attached to the third zoom unit 113, the zoom detector 106 and the third zoom unit 113 move together in the optical axis direction relative to the linear guide barrel 107 and the cam barrel 108. Thereby, the detecting knob 106a is moved in the optical axis direction by a lift amount of the cam groove 108b, which is a moving amount of the third zoom unit 113. In a case where the detecting groove 108c has a lift amount in the optical axis direction, the detecting knob 106a moves in the optical axis direction by the lift amount, and the combined lift amount with the lift amount of the cam groove 108b, which is a moving amount of the third zoom unit 113, becomes a moving amount of the detecting knob 106a in the optical axis direction.

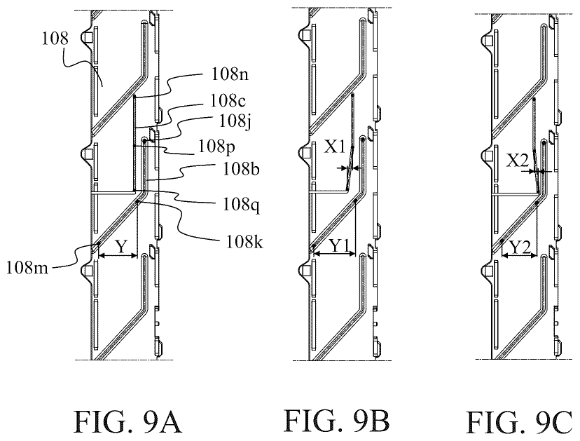

FIGS. 9A to 9C are developed views of the inner diameter of the cam barrel 108. Referring now to FIGS. 9A to 9C, a description will be given of a relationship between the cam groove 108b and the detecting groove 108c. The cam follower 113b is engaged with the cam groove 108b at a position 108j of the cam barrel 108 at the standby position in the non-imaging state. The cam follower 113b is engaged with the cam groove 108b at a position 108k of the cam barrel 108 at the wide-angle position in the imaging state, and engaged with the cam groove 108b at a position 108m of the cam barrel 108 at the telephoto position in the imaging state. The detecting knob 106a is engaged with the detecting groove 108c at a position 108n of the cam barrel 108 at the standby position in the non-imaging state. The detecting knob 106a is engaged with the detecting groove 108c at a position 108p of the cam barrel 108 at the wide-angle position in the imaging state, and engaged with the detecting groove 108c at a position 108q of the cam barrel 108 at the telephoto position in the imaging state.

FIG. 9A is a developed view of the inner diameter of the cam barrel 108 in a case where a moving amount of the third zoom unit 113 in the imaging state is approximately the same as a detection amount by the zoom detector 106 in the imaging state. Assume that Y is a moving amount of the third zoom unit 113 in the optical axis direction in the imaging state, S is a detection amount of the imaging state detecting range 106k of the zoom detector 106, and X is a lift amount of the detecting groove 108c of the cam barrel 108 in the optical axis direction in the imaging state. Then, Y=S, and therefore X=0. In other words, the lift amount of the detecting groove 108c in the optical axis direction is zero. In a case where the cam barrel 108 is a molded component, the detecting groove 108c is formed in an inner diameter slide, but since the lift amount is 0, it is unnecessary to provide a large die draft angle. Thereby, highly accurate position detection can be performed.

FIG. 9B is a developed view of the inner diameter of the cam barrel 108 in a case where a moving amount of the third zoom unit 113 in the imaging state is larger than a detection amount by the zoom detector 106 in the imaging state. Assume that Y1 is a moving amount of the third zoom unit 113 in the optical axis direction in the imaging state, S is a detection amount of the imaging state detecting range 106k of the zoom detector 106, and X1 is a lift amount of the detecting groove 108c of the cam barrel 108 in the optical axis direction in the imaging state. Then, Y1−X1=S.

FIG. 9C is a developed view of the inner diameter of the cam barrel 108 in a case where a moving amount of the third zoom unit 113 in the imaging state is smaller than a detection amount by the zoom detector 106 in the imaging state. Assume that Y2 is a moving amount of the third zoom unit 113 in the optical axis direction in the imaging state, S is a detection amount of the imaging state detecting range 106k of the zoom detector 106, and X2 is a lift amount of the detecting groove 108c of the cam barrel 108 in the optical axis direction in the imaging state. Then, Y2+X2=S.

Thereby, the lift amounts X, X1, and X2 in the imaging state in the optical axis direction of the detecting groove 108c may be set smaller than the imaging state detecting range 106k, and thus the size of the cam barrel 108 can be reduced. In addition, there is no need to provide the detecting groove 108c in the zoom operation ring 103, and the overall length of the zoom operation ring 103 in the optical axis direction can be shorter than the overall length of the zoom detector 106 in the optical axis direction, and the size of the lens barrel can be reduced. Moreover, the detection amount of the imaging state detecting range 106k of the zoom detector 106 is a combination of the lift amount Y of the cam groove 108b, which is a moving amount of the third zoom unit 113 as a position detection target, and the lift amount X of the detecting groove 108c of the cam barrel 108 in the imaging state. Thereby, highly accurate position detection can be performed.

In this embodiment, the zoom detector 106 is integrated with the third zoom unit 113. However, even in a case where the detecting knob 106a is engaged with the detecting groove 108c of the cam barrel 108 in a configuration in which the zoom detector 106 is held by an independent holding frame that moves in the optical axis direction (not illustrated), the miniaturization of the lens barrel and highly accurate position detection can be realized. In addition, even in a case where the detecting knob 106a is engaged with the detecting groove 108c of the cam barrel 108 in a configuration in which the zoom detector 106 is held in a fixed frame (not illustrated) which does not move in the optical axis direction, the miniaturization of the lens barrel and highly accurate position detection can be realized.

### Second Embodiment

In the first embodiment, the detecting groove 108c as the detection engaged part is provided on the cam barrel 108. The second embodiment is different from the first embodiment in that a detecting hole 107b serving as the detection engaged part is provided on the linear guide barrel 107. In the following, a description of the parts common to those of the first embodiment will be omitted, and only the parts different from those of the first embodiment will be described.

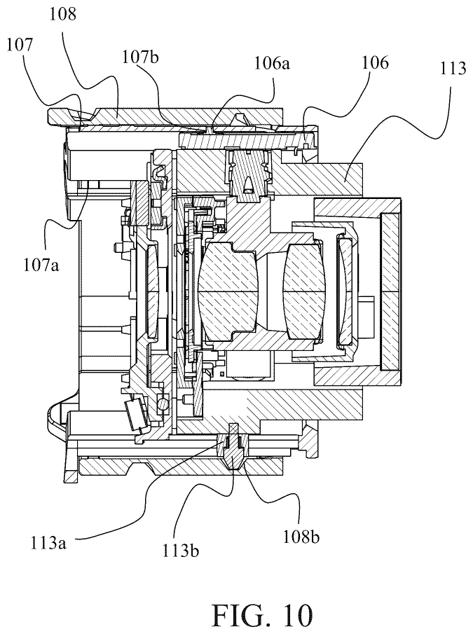

FIG. 10 is a sectional view illustrating a relationship between the zoom detector 106 and the linear guide barrel 107. The zoom detector 106 is attached to the third zoom unit 113. The detecting knob (the detection engaging part) 106a of the zoom detector 106 is engaged with the detecting hole (the detection engaged part) 107b provided on the linear guide barrel 107. A movable range of the detecting knob 106a is divided into the non-imaging state detecting range 106j and the imaging state detecting range 106k. When the cam barrel 108 rotates along with the rotation of the zoom operation ring 103, the third zoom unit 113 moves along the optical axis relative to the fixed barrel 109 since the cam follower 113b is engaged with the cam groove 108b. Thereby, the zoom detector 106 and the third zoom unit 113 move together in the optical axis direction relative to the linear guide barrel 107 and the cam barrel 108. Thereby, the detecting knob 106a is moved in the optical axis direction by the lift amount of the cam groove 108b, which is a moving amount of the third zoom unit 113. This configuration does not have to form the detecting groove 108c on the cam barrel 108, and can reduce the size of the cam barrel 108. In addition, there is no need to provide the detecting groove 108c on the zoom operation ring 103, and the overall length of the zoom operation ring 103 in the optical axis direction can be made shorter than the overall length of the zoom detector 106 in the optical axis direction, and the size of the lens barrel can be reduced. Moreover, by directly detecting a moving amount of the third zoom unit 113, highly accurate position detection can be realized.

In this embodiment, the zoom detector 106 is integrated with the third zoom unit 113. However, even in a case where the detecting knob 106a is engaged with the detecting hole 107b of the linear guide barrel 107 in a configuration in which the zoom detector 106 is held by an independent holding frame that moves in the optical axis direction (not illustrated), the miniaturization of the lens barrel and highly accurate position detection can be realized. In addition, in a case where the detecting knob 106a is engaged with the detecting hole 107b in a configuration in which the zoom detector 106 is held in an unillustrated fixed frame which does not move in the optical axis direction and the linear guide groove 107 moves in the optical axis direction, the miniaturization of the lens barrel and highly accurate position detection can be realized.

The above configuration can achieve further miniaturization of the lens barrel diameter direction and overall length of an optical apparatus such as the interchangeable lens 101, and realize the optical apparatus configured to detect the lens position with high accuracy.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

The present disclosure provides an optical apparatus that can reduce the size and detect a lens position with high accuracy.

What is claimed is:

1. An optical apparatus comprising:
a guide barrel configured to hold a lens unit movably in an optical axis direction;
a cam barrel rotatably held by the guide barrel;
a detecting member including a detection engaging part, and configured to perform a position detection of the lens unit by a movement of the detection engaging part; and
a fixed barrel in which the guide barrel, the cam barrel, and the detecting member are disposed,
wherein the detection engaging part is engaged with a detection engaged part provided on the cam barrel, and
wherein the detecting member is movable in the optical axis direction relative to the cam barrel.

2. An optical apparatus comprising:
a guide barrel configured to hold a lens unit movably in an optical axis direction;
a cam barrel rotatably held by the guide barrel;
a detecting member including a detection engaging part, and configured to perform a position detection of the lens unit by a movement of the detection engaging part; and
a fixed barrel in which the guide barrel, the cam barrel, and the detecting member are disposed,
wherein the detection engaging part is engaged with a detection engaged part provided on the guide barrel, and
wherein the detecting member is movable in the optical axis direction relative to the guide barrel.

3. The optical apparatus according to claim 1, wherein the detection engaged part is provided on an inner circumference of the cam barrel.

4. The optical apparatus according to claim 1, wherein the detection engaged part provided on the cam barrel is a detecting groove.

5. The optical apparatus according to claim 2, wherein the detection engaged part provided on the cam barrel is a detecting hole.

6. The optical apparatus according to claim 1, further comprising an operation ring held on an outer circumference of the fixed barrel,
wherein the cam barrel rotates along with a rotation operation of the operation ring.

7. The optical apparatus according to claim 1, wherein the detecting member is provided to the lens unit.

8. The optical apparatus according to claim 1, wherein the detecting member is movable in the optical axis direction relative to the fixed barrel.

9. The optical apparatus according to claim 1, wherein the lens unit and the detecting member move together.

10. The optical apparatus according to claim 1, wherein a lift amount of the detection engaged part in the optical axis direction in an imaging state is smaller than a detecting range of the detecting member.

11. The optical apparatus according to claim 6, wherein the operation ring in the optical axis direction is shorter than the detecting member in the optical axis direction.

12. The optical apparatus according to claim 1, wherein the detecting member is a resistive sensor.

13. The optical apparatus according to claim 1, wherein the detecting member is a linear displacement sensor.

14. The optical apparatus according to claim 2, further comprising an operation ring held on an outer circumference of the fixed barrel,
wherein the cam barrel rotates along with a rotation operation of the operation ring.

15. The optical apparatus according to claim 2, wherein the detecting member is provided to the lens unit.

16. The optical apparatus according to claim 2, wherein the detecting member is movable in the optical axis direction relative to the fixed barrel.

17. The optical apparatus according to claim 2, wherein the lens unit and the detecting member move together.

18. The optical apparatus according to claim 2, wherein a lift amount of the detection engaged part in the optical axis direction in an imaging state is smaller than a detecting range of the detecting member.

19. The optical apparatus according to claim 14, wherein the operation ring in the optical axis direction is shorter than the detecting member in the optical axis direction.

20. The optical apparatus according to claim 2, wherein the detecting member is a resistive sensor or a linear displacement sensor.
